(19) United States
(12) Patent Application Publication
(10) Pub. No.: US 2011/0181856 A1
(43) Pub. Date: Jul. 28, 2011

(54) Auto-focusing device and method for maskless exposure apparatus

(75) Inventors: Sang Min Lee, Yongin-si (KR); Sang Don Jang, Suwon-si (KR); Sang Hyun Park, Yongin-si (KR); Dong Seok Baek, Suwon-si (KR)

(73) Assignee: Samsung Electronics Co., Ltd., Suwon-si (KR)

(21) Appl. No.: 12/929,452

(22) Filed: Jan. 26, 2011

(30) Foreign Application Priority Data
Jan. 26, 2010 (KR) 10-2010-0006803

(51) Int. Cl. G03B 27/34

(52) U.S. Cl. 355/56

(57) ABSTRACT

Example embodiments are directed to an auto-focusing device for use in a maskless exposure apparatus that performs a beam focus calibration and an auto-focusing method using the same. The auto-focusing device includes a projection optical unit, a focus calibration unit, and a controller. The projection optical unit includes a distance measurement sensor and a focus controller that generate a beam of light. The focus calibration unit includes a substrate having a reference mark on which the beam generated from the projection optical unit is illuminated, a measuring optical unit configured to obtain image information of the beam illuminated on the reference mark, and a stage configured to support the substrate and the measuring optical unit. The controller is configured to control the focus controller so that a beam of the beam generated from the measuring optical unit is located on the surface of an exposed member.

### CROSS-REFERENCE TO RELATED APPLICATION(S)

This application claims priority under 35 U.S.C. §119 to Korean Patent Application No. 2010-0006803, filed on Jan. 26, 2010 in the Korean Intellectual Property Office, the entire disclosure of which is incorporated herein by reference.

### BACKGROUND

1. Field

Example embodiments relate to an auto-focusing device and method for maskless exposure apparatus capable of performing focus calibration.

2. Description of the Related Art

Exposure devices are used in a fabrication process of semiconductors and LCDs, for example. Generally, the exposure device allows a desired pattern to be exposed on a wafer or a glass substrate using a mask. However, when using a mask, a variety of problems may occur, for example, high cost of a mask or the substrate sagging due to a large-sized substrate. As a result, a maskless exposure device using a Spatial Light Modulator (SLM) such as a Digital Micromirror Device (DMD) is recently being used. The maskless exposure device turns a micromirror ON or OFF based on a desired pattern by emitting a light beam to the SLM in such a manner that a virtual mask can be used.

Due to the principle of the maskless exposure device, the size of a spot beam is of relatively high importance when determining resolution of the maskless exposure device. The smaller the spot beam size, the smaller the pattern to be exposed. A diameter of the spot beam is minimized at a focus of the spot beam. In this case, the exposure device can implement maximum performance. Therefore, an auto-focusing device, that is capable of adjusting a focus in response to a curved exposure surface of an exposure member to be exposed during the scanning exposure, is mounted to the maskless exposure apparatus. In order for the auto-focusing device to perform auto-focusing (AF), there is needed a method for measuring the distance to the focus of the spot beam using a height measurement sensor. In order to perform the AF during the scanning exposure, a moving status of the spot-beam focus and specific information indicating whether the spot focus is located on an exposure surface must be recognized. In this case, the moving status of the spot beam focus indicates that the focus of the spot beam moves from the height measured by the height measurement sensor. Accordingly, the exposure operation is performed while simultaneously experimentally moving the focus of the spot beam, and the exposure result is analyzed in such a manner that an optimum focus of the spot beam can be calculated. In this case, the measurement value of the height measurement sensor at a height of the calculated focus becomes the focus height of the spot beam. However, a long period of time is required to implement the above-mentioned method, a large-area high-speed exposure device in which several hard packings must be installed has different spot-beam focuses in respective hard packings, so that it is very difficult to recognize the height of focus of each hard packing through the exposure test.

### SUMMARY

According to example embodiments, an auto-focusing device for use in a maskless exposure apparatus includes a projection optical unit including a distance measurement sensor and a focus controller so as to generate a beam; a focus calibration unit including a substrate having a reference mark on which the beam generated from the projection optical unit is illuminated, measuring optical unit configured to obtain image information of the beam illuminated on the reference mark, and a stage configured to support the substrate and the measuring optical unit; and a controller configured to control the focus controller such that a focus of the beam generated from the projection optical unit is located on a surface of the reference mark and configured to control the distance measurement sensor to acquire a reference distance identical to a distance from the distance measurement sensor to the surface of the reference mark and a distance to the surface of an exposed member, wherein the controller is further configured to control the focus controller such that the focus of the beam generated from the projection optical unit is located on the surface of the exposed member according to a difference between the reference distance and the distance to the surface of the exposed member.

According to example embodiments, the measuring optical unit includes a photo-sensor.

According to example embodiments, the measuring optical unit includes an image sensor.

According to example embodiments, the image sensor is a CMOS sensor or a CCD sensor.

According to example embodiments, to locate the focus of the beam generated from the projection optical unit on the surface of the reference mark, the controller is further configured to: adjust a focus of the measuring optical unit to be located on the surface of the reference mark; vary the focus of the beam generated from the projection optical unit by controlling the focus controller, and illuminate the beam on the reference mark; use the image sensor to obtain image information of the beam illuminated on the reference mark; and analyze the image information of the beam illuminated on the reference mark, wherein a focus of the beam generated from the projection optical unit is selected when a size of the beam illuminated on the reference mark is minimized or intensity of the beam illuminated on the reference mark is maximum.

According to example embodiments, to adjust the focus of the measuring optical unit to be located on the surface of the reference mark includes, the controller is further configured to: adjust the stage to move the measuring optical unit up and down, and use the image sensor to obtain image information of the reference mark; and position the measuring optical unit such that a maximum clarity of the image information of the reference mark is obtained.

According to example embodiments, an auto-focusing method of a maskless exposure apparatus includes simultaneously varying a focus of a beam generated from projection optical unit and illuminating the generated beam on a surface of a reference mark; obtaining image information of the beam illuminated on the reference mark; adjusting a focus of the beam generated from the projection optical unit to be located on the surface of the reference mark according to the obtained image information of the beam; acquiring, by a distance measurement sensor installed in the projection optical unit, a reference distance from the distance measurement sensor to the reference mark surface and a distance from the distance measurement sensor to a surface of an exposed member; and adjusting the focus of the beam generated from the projection optical unit to be located on the surface of the exposed member according to a difference between the reference distance and the distance to the surface of the exposed member.

According to example embodiments, adjusting of the focus of the beam generated from the projection optical unit to be located on the surface of the reference mark according to the image information of the beam illuminated on the reference mark includes: selecting a focus of the beam generated from the projection optical unit such that a size of the beam illuminated on the reference mark is minimized or an intensity of the beam illuminated on the reference mark is maximized.

According to example embodiments, the auto-focusing method further includes obtaining, using measuring optical unit, the image information of the beam illuminated on the reference mark.

According to example embodiments, the auto-focusing method further includes providing an image sensor in the measuring optical unit.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a perspective view illustrating a maskless exposure apparatus including an auto-focusing device according to example embodiments.

FIG. 2 illustrates a multi-beam measurement status of a maskless exposure apparatus including an auto-focusing device according to example embodiments.

FIG. 3(a) shows a focus of a beam when the focus calibration is not performed, according to example embodiments.

FIG. 3(b) shows a focus of a beam when the focus calibration is performed, according to example embodiments.

FIG. 4 illustrates an auto-focusing device of a maskless exposure apparatus according to example embodiments.

FIG. 5 illustrates a substrate including a reference mark installed in an auto-focusing device of a maskless exposure apparatus according to example embodiments.

FIG. 6(a) illustrates a condition wherein the measuring optical unit of an auto-focusing device moves up, according to example embodiments.

FIG. 6(b) illustrates a condition wherein the measuring optical unit of an auto-focusing device moves down, according to example embodiments.

FIG. 6(c) illustrates a condition wherein the measuring optical unit of an auto-focusing apparatus is focused, according to example embodiments.

FIGS. 7(a) and 7(b) illustrate image information of a reference mark when a measuring optical unit of an auto-focusing device of a maskless exposure apparatus moves higher from its position illustrated in FIG. 7(c).

FIG. 7(c) illustrates a image information of a reference mark obtained using a measuring optical unit of an auto-focusing device of a maskless exposure apparatus.

FIGS. 7(d) and 7(e) illustrate image information of a reference mark when a measuring optical unit of an auto-focusing device of a maskless exposure apparatus moves lower from its position illustrated in FIG. 7(c).

FIG. 8(a) illustrates example variations in image intensity information.

FIG. 8(b) illustrates a portion of the reference mark illustrates in FIGS. 7(a)-(e).

FIG. 9(a) illustrates that the focus of the beam emitted from the projection optical unit is formed at a point higher than the surface of the reference mark.

FIG. 9(b) illustrates that the focus of the beam emitted from the projection optical unit is formed at a point lower than the surface of the reference mark.

FIG. 9(c) illustrates that the focus of the beam emitted from the projection optical unit is located on the surface of the reference mark.

FIG. 10(a) illustrates a circular beam illuminated at the center of the reference mark.

FIGS. 10(b), 10(c) and 10(d) different sizes of the circular beam illuminated at the center of the reference mark.

FIG. 11(a) illustrates a variation in the beam size from the focal position of the beam emitted from the projection optical unit.

FIG. 11(b) illustrates a graph of the beam intensity information for a center of the beam emitted from the projection optical unit.

FIG. 11(c) is a graph illustrating a change in the beam size information when the focus of the beam emitted from the projection optical unit is changed.

FIG. 12 illustrates an operation in which a distance measurement sensor of an auto-focusing device of a maskless exposure apparatus measures a distance to a reference mark.

FIG. 13 illustrates a scanning exposure operation in which a focus of a beam generated from a projection optical unit is calibrated using a focus calibration device of the maskless exposure apparatus, and a beam emitted from an optical unit is auto-focused in response to the surface of an exposure member to be exposed.

FIG. 14 is a flowchart illustrating an auto-focusing method of a maskless exposure apparatus according to example embodiments.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

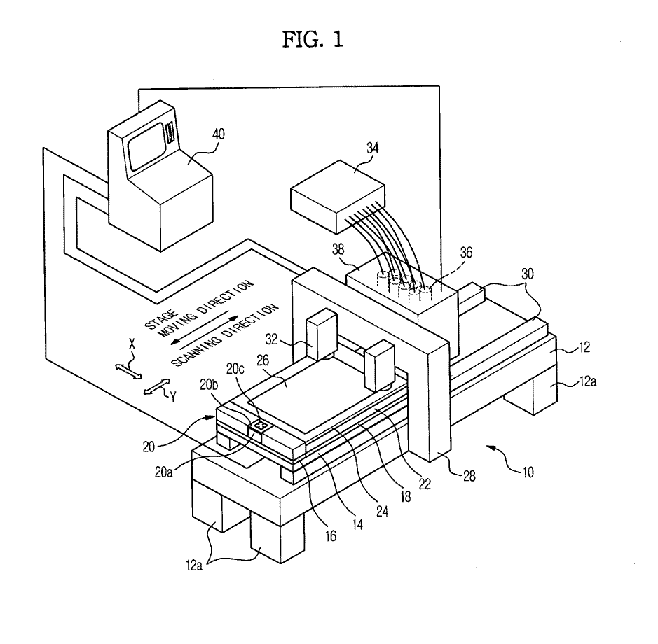

FIG. 1 is a perspective view illustrating a maskless exposure apparatus 10 including an auto-focusing device according to example embodiments.

Referring to FIG. 1, the maskless exposure apparatus 10 is configured in the form of a flat bed, and includes a table 12 supported by four leg members 12a and an y-axis stage 14 that is movable in an Y-axis direction on a guide 30 placed on the table 12. A first X-axis stage 16 and a second X-axis stage 18 that are movable in the X-axis direction are located on the y-axis stage 14. The focus calibration device 20 is placed on the first X-axis stage 16. A chuck 22 and a glass 24 are located on the second X-axis stage 18. A photosensitive material 26 such as a PR layer (PhotoResist layer) is deposited on the glass 24. A gate-shaped frame 28 is coupled to the center part of the table 12, and two position sensors 32 are located at one side, for example, the left side, of the gate-shaped frame 28. Each position sensor 32 detects the movement of each stage 14, 16, and/or 18, and transmits the detected signal to a controller 40 to be described later. The first X-axis stage 16 moves the focus calibration device 20 in the X-axis direction, and the second X-axis stage moves the chuck 22 in the X-axis direction. The Y-axis stage 14 simultaneously moves the calibration device 20 and the chuck 22 in the Y-axis direction.

A light source 34 for generating a light beam such as a laser beam and an exposure head unit 38 including multiple exposure heads 36 are installed on the side of the gate-shaped frame 28 opposite to the position sensors 32. The exposure head unit 38 receives a beam from the light source unit 34, and directs multiple beams to a photosensitive material 26 through the multiple exposure heads 36, such that it forms an image of a desired pattern.

The focus calibration device 20 is coupled to a side, for example, a left side, of the chuck 22. The focus calibration device 20 includes a measuring optical unit 20a, a substrate 20b, and a reference mark 20c. A detailed structure and operation of the focus calibration device 20 is described.

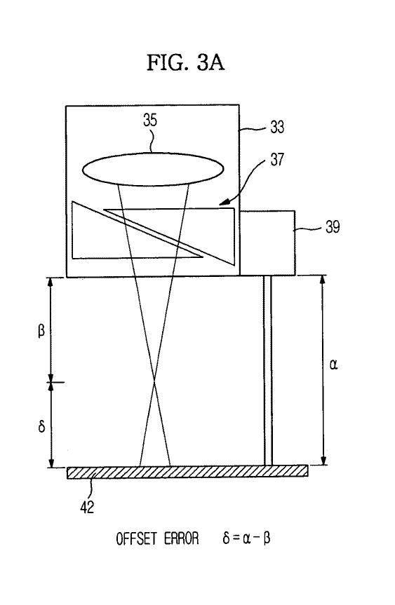

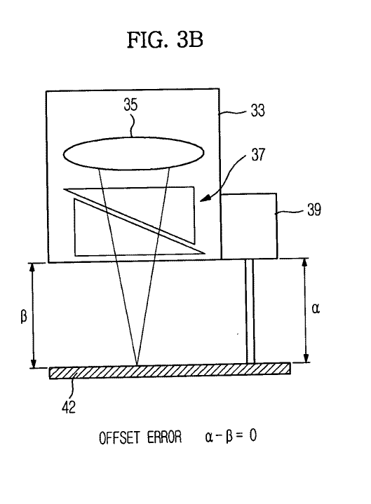

The controller 40 controls the spatial light modulator (SLM) (not shown) on the basis of exposure data of a desired pattern, illuminates multiple beams, and controls a focus controller 37 (FIG. 3A) and a measuring optical unit 20a, such that it adjusts a focus of the beam emitted from the projection optical unit 33 (described later).

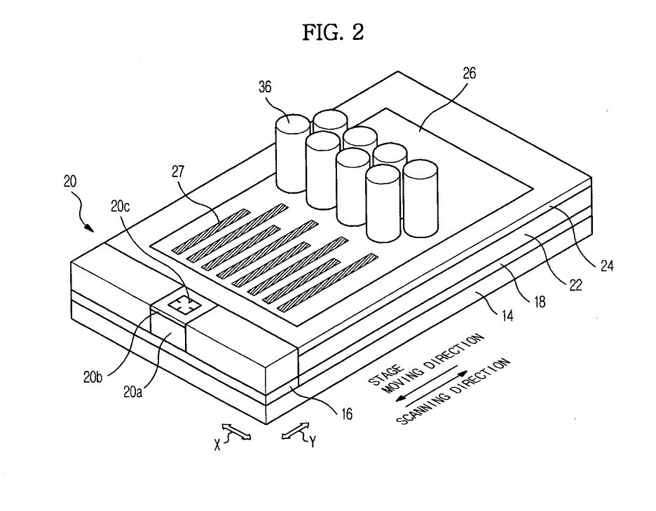

FIG. 2 illustrates a multi-beam measurement status of the maskless exposure apparatus 10 including an auto-focusing device according to example embodiments.

Referring to FIG. 2, the Y-axis stage 14 moves in the stage moving direction denoted by an arrow. While the Y-axis stage 14 moves in the arrow direction, the Y-axis stage 14 illuminates multiple beams on the photosensitive material through the multiple exposure heads 36, such that an image of a desired pattern is formed. An example 27 of the generated pattern image is shown in FIG. 2. Prior to forming the generated pattern image 27, it is suggested that the focus calibration of beams emitted from individual multiple exposure heads 36 initially be carried out. The focus calibration is carried out when multiple exposure heads 36 first pass through the focus calibration device 20 of FIG. 2. The focus calibration will hereinafter be described with reference to FIG. 3.

FIG. 3 illustrates the principles of operations of an auto-focusing device of the maskless exposure apparatus 10 according to example embodiments.

The projection optical unit 33 is configured to include the light source unit 34 (not shown in FIG. 3) and the exposure head unit 38 including the multiple exposure heads 36 (not shown in FIG. 3), and is used to generate multiple beams. The projection optical unit 33 further includes a lens unit 35, a focus controller 37, and/or a distance measurement sensor 39. The beam emitted from the light source unit 34 passes through the lens unit 35, a focus of the beam is changed by the focus controller 37, and the resultant beam is illuminated on a reference surface 42. The reference surface 42 on which the generated beam is illuminated is shown in FIG. 3. The reference surface 42 is used as a reference for performing focus calibration, and performs the same role as the surface of the reference mark 20c. That is, the reference surface 42 is indicative of a certain reference surface on which the same focus calibration as on the surface of the reference mark 20c is performed.

The distance measurement sensor 39 measures a reference distance identical to the distance to the reference surface 42. In response to a difference between a distance from the distance measurement sensor 39 to the exposure member to be exposed and the reference distance, the focus controller 37 controls the focus of the beam emitted from the projection optical unit 33 in response to the surface of the exposure member to be exposed. That is, the focus controller 37 controls the focus of a beam emitted from the projection optical unit 33 to be increased or reduced from an initial value in response to a newly-measured distance to an exposed member on the basis of the reference distance. In this case, it may be required for the focus of the beam emitted from the projection optical unit 33 to be adjusted on the reference surface 42, such that the curved exposure member to be exposed can be auto-focused while being exposed. In this way, the focus of the beam initially emitted from the projection optical unit 33 must be adjusted on the reference surface 42, and the above-mentioned focusing will hereinafter be referred to as a focus calibration. The focus calibration will hereinafter be described with reference to FIG. 3.

FIG. 3(a) shows a focus of a beam emitted from the projection optical unit 33 under the condition that the focus calibration is not performed. The distance to the reference surface 42 is measured as ‘α’ by the distance measurement sensor 39. For convenience of description and better understanding of example embodiments, it is assumed that the distance from the distance measurement sensor 39 to the focus of the beam emitted from the projection optical unit 33 is set to ‘β’, and the distance from the reference surface 42 to the focus of the beam emitted from the projection optical unit 33 is set to ‘δ’. In this case, an offset error ‘δ’ indicating a difference between the reference surface 42 and the focus of the beam emitted from the projection optical unit 33 is defined by an equation ‘δ=α−β’.

In FIG. 3(a), the equation ‘δ=α−β’ is non-zero. If the auto-focusing is performed under the condition that the equation ‘δ=α−β’ is non-zero, it is difficult to perform correct focusing on the surface of the exposed member. FIG. 3(b) shows a focus calibration status caused by the equation ‘δ=α−β’ denoted by zero. If the exposed member is exposed under the condition that focus calibration is carried out, the auto-focusing can be correctly performed on the surface of the exposed member on the basis of the distance measured by the distance measurement sensor.

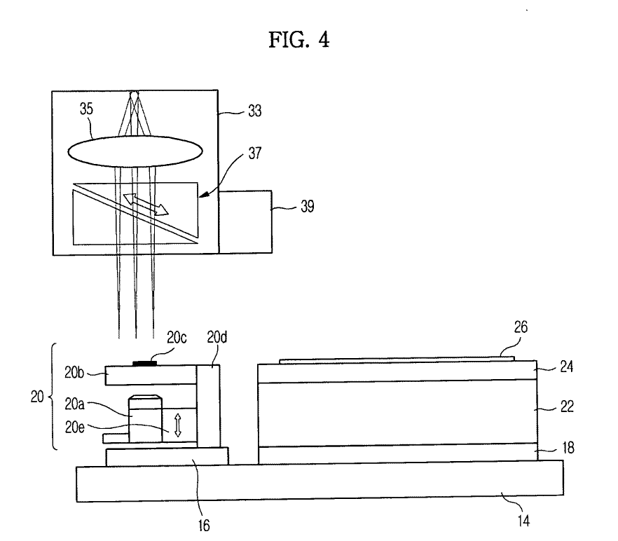

FIG. 4 is a diagram illustrating an auto-focusing device of the maskless exposure apparatus 10 according to example embodiments.

Referring to FIG. 4, the auto-focusing device of the maskless exposure apparatus includes a focus calibration device 20 and the controller 40 of FIG. 1. The controller 40 designed to perform the auto-focusing can perform the auto-focusing and at the same time can control the maskless exposure apparatus 10. Although not shown in FIG. 4, the controller 40 may be configured separately from the apparatus for controlling the maskless exposure apparatus 10. The projection optical unit 33 includes a lens unit 35 and a focus controller 37, and a distance measurement sensor 39 is installed outside of the projection optical unit 33. However, location and position of the distance measurement sensor 39 is limited thereto and the distance measurement sensor 39 may be installed at any location that facilitates correct measurement. The second X-axis stage 18, the chuck 22, the glass 24, and the photosensitive material 26 are sequentially located at the right upper part of the Y-axis stage 14. The first X-axis stage 16 is located at the left upper part of the Y-axis stage 14, the support 20d is connected to an upper part of the first X-axis stage 16, and the substrate 20b and the Z-axis stage 20e are connected to the support 20d. A reference mark 20c is formed on the substrate 20b, and the measuring optical unit 20a is connected to the Z-axis stage 20e. Although FIG. 4 illustrates only one focus calibration device 20, a plurality of focus calibration devices 20 may be installed under the condition that a large number of multiple exposure heads 36 are used, and individual calibration devices 20 are driven separately from each other, such that focusing of the beam emitted from the optical unit 33 may be formed on the surface of each reference mark 20c.

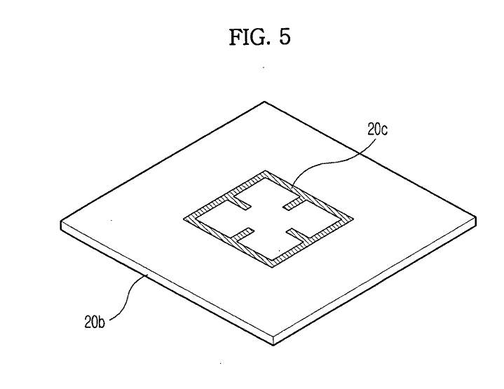

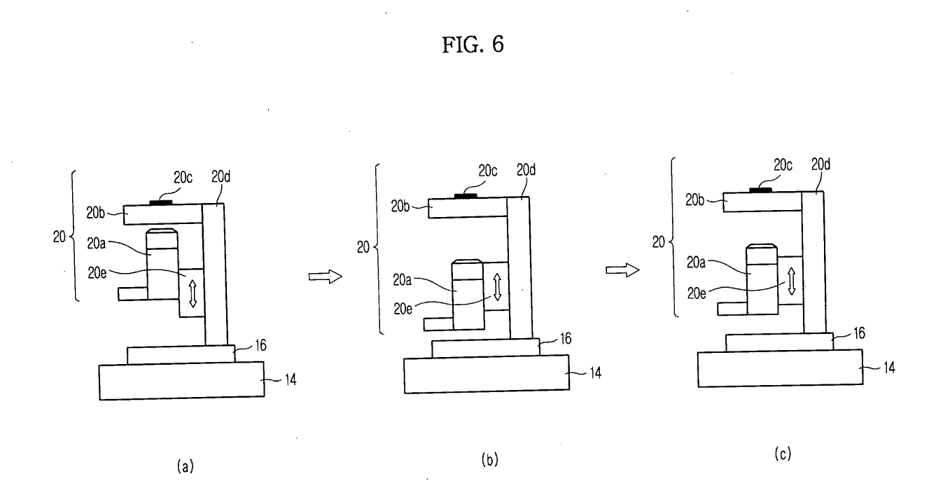

The substrate 20b may be formed of a transparent glass. The measuring optical unit 20a may move up and down by driving of the Z-axis stage 20e, so that the light beam maybe focused on the surface of the reference mark 20c. FIG. 5 illustrates a substrate 20b including a reference mark 20c installed in the auto-focusing device of the maskless exposure apparatus according to example embodiments. The reference mark 20c may be formed of an opaque material such as metal or plastic, and may be formed in various desired shapes. In FIG. 4, the Y-axis stage 14 moves, for example, from the right to the left so as to first perform focus calibration, then the photosensitive material 26 is exposed. The operation principles thereof will hereinafter be described with reference to FIGS. 6 to 13.

FIG. 6 illustrates an operation in which a focus of the measuring optical unit 20a of the auto-focusing device of the maskless exposure apparatus 10 is located on the surface of the reference mark 20c.

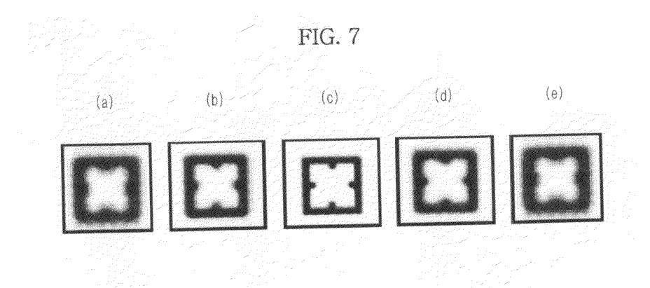

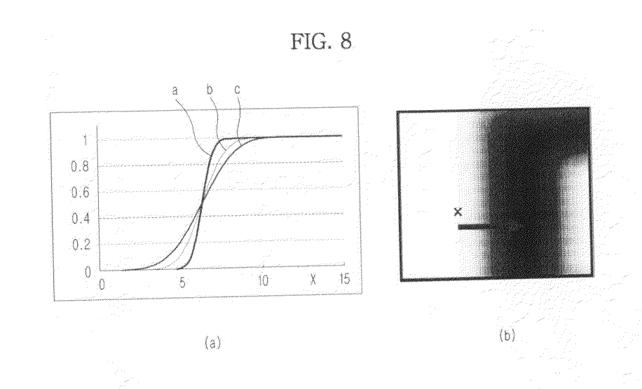

Referring to FIG. 6, in order to correctly measure the surface of the reference mark 20c using the measuring optical unit 20a, it may be required for the focus of the measuring optical unit 20a to be located on the surface of the reference mark 20c. The controller 40 moves the first X-axis stage 16 and the Y-axis stage 14, so that the reference mark 20c is located at a lower part of the projection optical unit 33. Thereafter, the controller 40 moves the Z-axis stage 20e, so that the focus of the measuring optical unit 20a is located on the surface of the reference mark 20c. Needless to say, according to a variety of design methods, the controller 40 may move the Z-axis stage 20e so that the focus of the measuring optical unit 20a is located on the surface of the reference mark 20c. Then, the controller 40 may move the Y-axis stage 14 and the first X-axis stage 16 so that the reference mark 20c may also be located at a lower part of the projection optical unit 33. At this time, the adjusting the focus of the measuring optical unit 20a on the surface of the reference mark 20c can be carried out by the following example method. The measuring optical unit 20a moves up as shown in FIG. 6(a), and then moves down as shown in FIG. 6(b). Referring to FIG. 6(c), the measuring optical unit 20a is located at a height where the focus of the measuring optical unit 20a is formed on the surface of the reference mark 20c using the methods shown in FIGS. 7 and 8. Needless to say, the measuring optical unit 20a may move down and move up as necessary. In this case, a method for searching for a height where the focus of the measuring optical unit 20a is located on the surface of the reference mark 20c will hereinafter be described with reference to FIGS. 7 and 8.

FIG. 7 illustrates image information of a reference mark 20c measured when the measuring optical unit 33 of the auto-focusing device of the maskless exposure apparatus moves up and down. FIG. 8 illustrates a variation of light intensity of image information of the reference mark shown in FIG. 7.

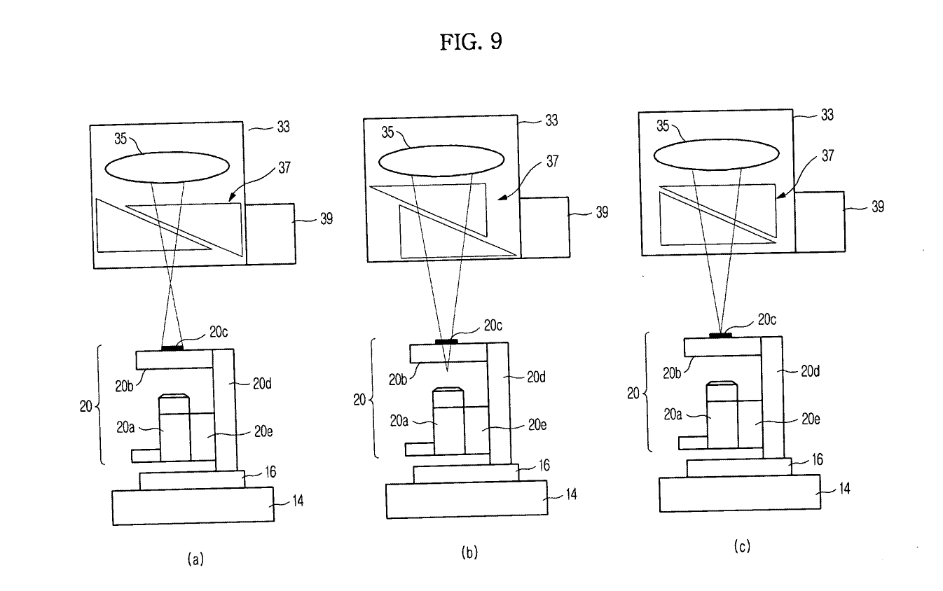

The measuring optical unit 20a comprised of a microscope or the like may include a photo-sensor and/or an image sensor. The photo-sensor may measure the light intensity information of the image measured by the measuring optical unit 20a. The image sensor may be comprised of a CMOS sensor or a CCD sensor. The CCD sensor may measure the light intensity information and the location information of the image measured by the measuring optical unit 20a. FIG. 7 shows image information of the reference mark 20c obtained by the image sensor installed in the measuring optical unit 20a. The Z-axis stage 20d moves and the measuring optical unit 20a moves up and down, so that image information of the reference mark 20c is obtained. The obtained image information is shown in FIG. 7(c) illustrating a relatively clear image information, for example. If the clear image information is obtained as shown in FIG. 7(c), the focus of the measuring optical unit 20a is located on the surface of the reference mark 20c. If the measuring optical unit 20a moves up or down on the basis of the location of FIG. 7(c), the image of the reference mark 20c becomes faint as shown in FIG. 7(a), 7(b), 7(d), or 7(e). FIGS. 7(a) and 7(b) illustrate image information of the reference mark 20c when the measuring optical unit 20a moves from the position (c) to a higher position. FIGS. 7(d) and 7(e) illustrate image information of the reference mark 20c when the measuring optical unit 20a moves from the position (c) to a lower position. In this case, the method for searching for the position where the image information of the clear reference mark 20c is obtained will hereinafter be described. If the image information of the reference mark 20c is obtained by the image sensor such as the CCD sensor, the light intensity information of a certain pixel line of an X-axis or Y-axis associated with the obtained image information is obtained. FIG. 8(b) illustrates a specific part of the reference mark 20c. An example of the obtained light intensity information is shown in FIG. 8(a). In FIG. 8(a), ‘a’, ‘b’ and ‘c’ illustrate different light intensities in response to clearness values of the obtained image. The clearer the image of the reference mark 20c, the faster the variation of the light intensity information within a predetermined/desired pixel interval. The lower the clearness of the image of the reference mark 20c, the slower the variation of the light intensity information within a predetermined/desired pixel interval. In other words, FIG. 8(a) illustrates that the clearness of the reference mark (20c) images are arranged in the order of c→b→a. That is, the light intensity information is obtained from a predetermined/desired pixel interval, and the obtained light intensity information is abruptly changed in the predetermined pixel interval. Namely, the measuring optical unit 20a is located at a position where the highest slope value of the light intensity variation is provided, such that the focus of the measuring optical unit 20a can be located on the surface of the reference mark 20c. In this way, if the focus of the measuring optical unit 20a is located on the surface of the reference mark 20c, the focus of the beam emitted from the projection optical unit 33 must also be located on the surface of the reference mark 20c, and a detailed description thereof will hereinafter be described with reference to FIGS. 9 to 11.

FIG. 9 illustrates an operation in which a focus of a light beam emitted from the projection optical unit 33 of an auto-focusing device of the maskless exposure apparatus 10 is located on the surface of a reference mark.

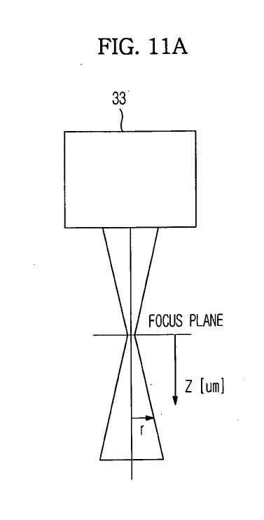

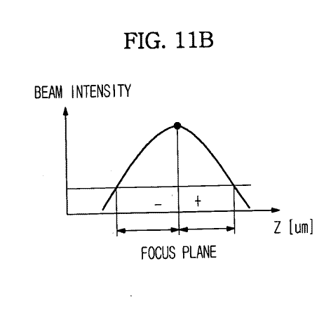

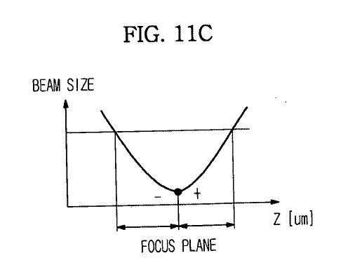

Referring to FIG. 9, the controller 40 controls the focus controller 37 so as to vary the focus of the beam emitted from the projection optical unit 33. FIG. 9(a) illustrates that the focus of the beam emitted from the projection optical unit 33 is formed at a point higher than the surface of the reference mark 20c. FIG. 9(b) illustrates that the focus of the beam emitted from the projection optical unit 33 is formed at a point lower than the surface of the reference mark 20c. A detailed description thereof will be described later with reference to FIG. 11(a). If the focus of the beam is formed at a point higher or lower than the reference mark surface, the size of the beam illuminated on the reference mark 20c becomes larger as compared to the case in which the focus of the beam emitted from the projection optical unit 33 is located on the surface of the reference mark 20c. FIG. 9(c) illustrates that the focus of the beam emitted from the projection optical unit 33 is located on the surface of the reference mark 20c so that the focus calibration is performed. In this case, the size of the beam illuminated on the reference mark 20c is minimized so that the exposure performance is maximized. In this way, the focus of the beam emitted from the projection optical unit 33 is changed by the control of the focus controller 37, and at the same time the measuring optical unit 20a measures the beam at the height of the surface of the reference mark 20c.

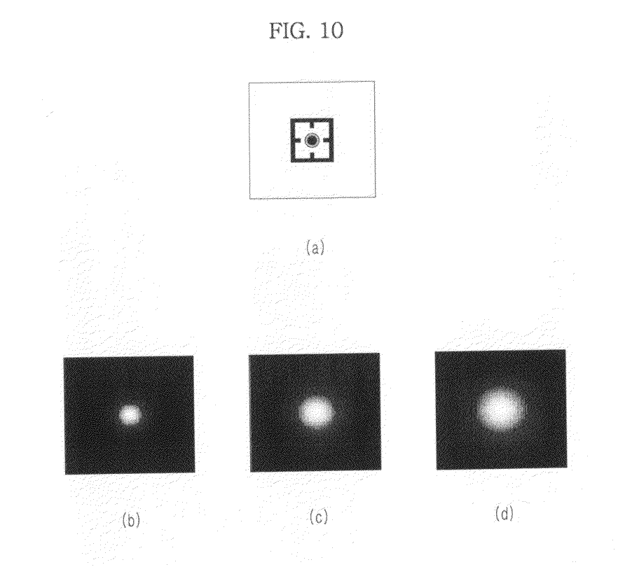

FIG. 10 illustrates image information obtained from the measuring optical unit which measures a light beam emitted from the projection optical unit of the auto-focusing device of the maskless exposure apparatus.

As can be seen from FIG. 10(a), the circular beam illuminated at the center of the reference mark 20c is formed. Different sizes of the circular beam illuminated at the center part of the reference mark 20c are shown in FIGS. 10(b), 10(c) and 10(d). The beam of FIG. 10(b) is the smallest, and the beam of FIG. 10(d) is the largest. The beam size is measured by a Full Width Half Maximum (FWHM) method using the light intensity information obtained by either the photo-sensor or the image sensor. In more detail, a diameter of a specific position corresponding to the half of the maximum beam intensity in the beam intensity distribution graph is determined to be the beam size. A method for searching for a specific case in which the measured beam size is the smallest as shown in FIG. 10(a) will hereinafter be described with reference to FIG. 11.

FIG. 11 illustrates the intensity of beam of the image information of FIG. 10 and the magnitude of the beam.

As can be seen from FIG. 11(a), the beam size is minimized at the focus position of the beam emitted from the projection optical unit 33. As the distance from the position of the minimum beam size increases, the beam size becomes larger. That is, if the controller 40 varies the focus of the beam emitted from the projection optical unit 33 by controlling the focus controller 37, the beam size at the height of the surface of the reference mark 20c is changed in response to the variation of the beam focus. In this case, if the beam intensity information of a specific position corresponding to the center of the beam is obtained, the graph of FIG. 11(b) is obtained. That is, the same beam energy is provided, so that the beam intensity decreases as the beam size becomes larger. As the beam size decreases, the beam intensity measured at the center position of the beam becomes larger. In this way, after the beam intensity information in response to the focus position of the beam emitted from the projection optical unit 33 is obtained, if the focus of the beam emitted from the projection optical unit 33 is selected when the beam intensity is maximized, the focus calibration can be carried out. However, it is relatively difficult to search for a specific point where the beam intensity is maximized, so the beam intensity is compared with a predetermined/desired threshold value I_{T} and is approximated on the basis of the center of two points each having the threshold value I_{T} in such a manner that the focus calibration can be performed.

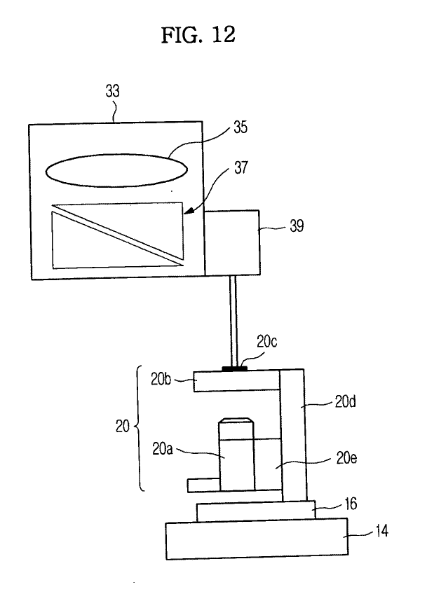

FIG. 11(c) is a graph illustrating the beam size information obtained when the focus of the beam emitted from the projection optical unit 33 is changed under the control of the focus controller 37. As previously stated above, the beam size is obtained by the FWHM method, and the focus calibration is carried out at a specific point where the beam size is minimized. Likewise, if the focus of the beam emitted from the projection optical unit 33 is selected when the beam size is minimized, the focus calibration can be carried out. However, it is relatively difficult to search for a specific point where the beam intensity is minimized, so that the beam intensity is compared with a predetermined/desired threshold value R_{T} and is approximated on the basis of the center of two points each having the threshold value R_{T} in such a manner that the focus calibration can be performed. An example case in which the beam emitted from the projection optical unit 33 is a single beam has been disclosed as described above. That is, the single beam is illuminated on the surface of the reference mark 20c, so that the focus of the beam emitted from the projection optical unit 33 is located on the surface of the reference mark 20c using the image information of the single beam. However, the projection optical unit 33 may perform focus calibration using a plurality of beams (for example, 5 beams). In the case where 5 beams are illuminated on the reference mark 20c, information about the case in which the focus of each beam is located on the surface of the reference mark 20c is calculated using image information of each beam, the average value of the calculated results of respective beams is calculated, and the focus calibration is carried out according to the average value. If the focus of the beam emitted from the projection optical unit 33 is located on the surface of the reference mark 20c, it is necessary for the distance measurement sensor 39 to measure the distance to the reference mark 20c, and a detailed description thereof will hereinafter be described with reference to FIG. 12.

FIG. 12 illustrates an operation in which a distance measurement sensor 39 of the auto-focusing device of the maskless exposure apparatus 10 measures a distance to the reference mark 20c. That is, the controller 40 controls the focus of the beam emitted from the projection optical unit 33 to be located on the surface of the reference mark 20c, and moves the Y-axis stage 14 and the first X-axis stage 16 in a manner that the reference mark 20c is located at a lower part of the distance measurement sensor 39, such that the reference distance identical to the distance to the reference mark 20c can be obtained. In other words, in response to the reference distance, the focus of the beam emitted from the projection optical unit 33 is located on the surface of the reference mark 20c located at the reference distance, so that the auto-focusing can be correctly carried out when the exposure member is exposed. Needless to say, before the focus of the beam emitted from the projection optical unit 33 is located on the surface of the reference mark 20c, the distance to the surface of the reference mark 20c may first be measured by the distance measurement sensor 39. As described above, if the focus of the beam emitted from the projection optical unit 33 is located on the surface of the reference mark 20c, and the distance to the surface of the reference mark 20c is measured by the distance measurement sensor 39, the focus calibration can be completed.

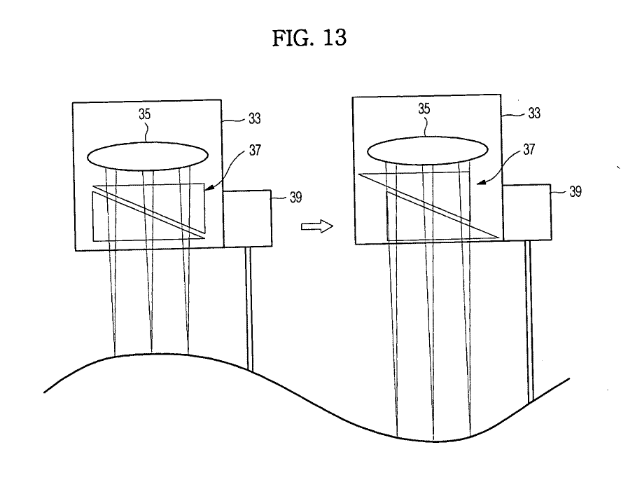

FIG. 13 is a diagram illustrating a scanning exposure operation in which a focus of a beam generated from a projection optical unit is calibrated using a focus calibration device of the maskless exposure apparatus 10, and a beam emitted from an optical unit is auto-focused in response to the surface of an exposure member to be exposed.

After the focus calibration is completed, the controller 40 controls the focus controller 37 such that the focus of the beam emitted from the projection optical unit 33 is located on the surface of the exposed member in response to a difference between a reference distance and the distance (to the exposed member) measured by the distance measurement sensor 39. In this case, a difference in distance between the position of the distance measurement sensor 39 and the position of the beam emitted from the projection optical unit 33 may occur. After the time calculated in response to the speed of the Y-axis stage 14 has elapsed, the controller 40 controls the focus to be adjusted in response to the calculated time, such that the above-mentioned distance difference can be prevented. As can be seen from FIG. 13, the beam emitted from the projection optical unit 33 is focused on the surface of the curved exposed member and the auto-focusing is carried out.

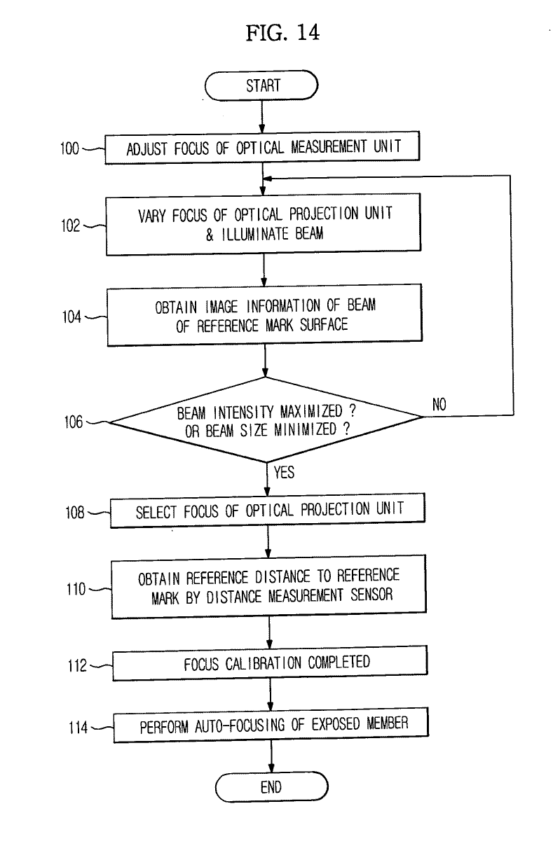

FIG. 14 is a flowchart illustrating an auto-focusing method of the maskless exposure apparatus according to example embodiments.

Referring to FIG. 14, the controller 40 moves the Y-axis stage 14 and the first X-axis stage 16, such that the reference mark 20c is located under the projection optical unit 33 and the focus of the measuring optical unit 20a is located on the surface of the reference mark 20c at operation 100. As previously stated above, the case in which the image measured by the image sensor of the measuring optical unit 20a is the clearest is selected, the operation 100 is carried out. If the focus of the measuring optical unit 20a is formed on the surface of the reference mark 20c, the controller 40 controls the focus controller 37 to vary the focus of the beam emitted from the projection optical unit 33 in such a manner that the beam is illuminated on the surface of the reference mark 20c at operation 102. In this case, the image sensor of the measuring optical unit 20a obtains image information of the beam at the height of the surface of the reference mark 20c at operation 104. Based on the analysis result of the image information, it is determined whether the beam intensity is maximized or the beam size is minimized at operation 106. If the beam intensity is not maximized or the beam size is not minimized at operation 106, the controller 40 controls the focus controller 37 to vary the focus of the beam emitted from the projection optical unit 33 in such a manner that the beam is illuminated on the surface of the reference mark 20c at operation 102. The focus formed when the beam intensity is maximized or the beam size is minimized is selected as a focus of the beam emitted from the projection optical unit 33 at operation 108. Next, the distance to the distance measurement sensor 39 is obtained at operation 110, such that the focus calibration of the maskless exposure apparatus is completed at operation 112. Under this condition, the Y-axis stage 14 moves in such a manner that the exposure member to be exposed is exposed and auto-focusing is carried out at operation 114.

By the above-mentioned example embodiments, the exposure test is repeatedly carried out, and the result of the exposure test is analyzed, such that the focus calibration of the spot beam is carried out using the measuring optical unit 20a without searching for the height of the spot-beam focus. As a result, the exposure action can be quickly carried out through a simple structure.

As is apparent from the above description, the auto-focusing device and method for the maskless exposure apparatus repeatedly performs the exposure test, and analyzes the test result, such that it need not search for the height of the spot-beam focus, but performs focus calibration of the spot beam before a measuring optical unit performs an exposure operation, such that the exposure can be quickly carried out using a simple structure.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An auto-focusing device for use in a maskless exposure apparatus, comprising:
a projection optical unit including a distance measurement sensor and a focus controller so as to generate a beam;
a focus calibration unit including a substrate having a reference mark on which the beam generated from the projection optical unit is illuminated, measuring optical unit configured to obtain image information of the beam illuminated on the reference mark, and a stage configured to support the substrate and the measuring optical unit; and
a controller configured to control the focus controller such that a focus of the beam generated from the projection optical unit is located on a surface of the reference mark and configured to control the distance measurement sensor to acquire a reference distance identical to a distance from the distance measurement sensor to the surface of the reference mark and a distance to the surface of an exposed member,
wherein the controller is further configured to control the focus controller such that the focus of the beam generated from the projection optical unit is located on the surface of the exposed member according to a difference between the reference distance and the distance to the surface of the exposed member.

2. The auto-focusing device according to claim 1, wherein the measuring optical unit includes a photo-sensor.

3. The auto-focusing device according to claim 1, wherein the measuring optical unit includes an image sensor.

4. The auto-focusing device according to claim 3, wherein the image sensor is a CMOS sensor or a CCD sensor.

5. The auto-focusing device according to claim 3, wherein, to locate the focus of the beam generated from the projection optical unit on the surface of the reference mark, the controller is further configured to:
adjust a focus of the measuring optical unit to be located on the surface of the reference mark;
vary the focus of the beam generated from the projection optical unit by controlling the focus controller, and illuminate the beam on the reference mark;
use the image sensor to obtain image information of the beam illuminated on the reference mark; and
analyze the image information of the beam illuminated on the reference mark,
wherein a focus of the beam generated from the projection optical unit is selected when a size of the beam illuminated on the reference mark is minimized or intensity of the beam illuminated on the reference mark is maximum.

6. The auto-focusing device according to claim 5, wherein to adjust the focus of the measuring optical unit to be located on the surface of the reference mark includes, the controller is further configured to:
adjust the stage to move the measuring optical unit up and down, and use the image sensor to obtain image information of the reference mark; and
position the measuring optical unit such that a maximum clarity of the image information of the reference mark is obtained.

7. An auto-focusing method of a maskless exposure apparatus, the method comprising:
simultaneously varying a focus of a beam generated from projection optical unit and illuminating the generated beam on a surface of a reference mark;
obtaining image information of the beam illuminated on the reference mark;
adjusting a focus of the beam generated from the projection optical unit to be located on the surface of the reference mark according to the obtained image information of the beam;
acquiring, by a distance measurement sensor installed in the projection optical unit, a reference distance from the distance measurement sensor to the reference mark surface and a distance from the distance measurement sensor to a surface of an exposed member; and
adjusting the focus of the beam generated from the projection optical unit to be located on the surface of the exposed member according to a difference between the reference distance and the distance to the surface of the exposed member.

8. The auto-focusing method according to claim 7, wherein adjusting of the focus of the beam generated from the projection optical unit to be located on the surface of the reference mark according to the image information of the beam illuminated on the reference mark includes:
selecting a focus of the beam generated from the projection optical unit such that a size of the beam illuminated on the reference mark is minimized or an intensity of the beam illuminated on the reference mark is maximized.

9. The auto-focusing method according to claim 7, further comprising:
obtaining, using measuring optical unit, the image information of the beam illuminated on the reference mark.

10. The auto-focusing method according to claim 9, further comprising:
providing an image sensor in the measuring optical unit.
